(19) United States
(12) Patent Application Publication
(10) Pub. No.: US 2015/0181513 A1
(43) Pub. Date: Jun. 25, 2015

(54) DEFERRED DOMAIN SELECTION IN A MOBILE COMMUNICATIONS NETWORK

(71) Applicant: Broadcom Corporation, Irvine, CA (US)

(72) Inventor: Badarinath Sharma, Bangalore (IN)

(73) Assignee: Broadcom Corporation, Irvine, CA (US)

(21) Appl. No.: 14/134,455

(22) Filed: Dec. 19, 2013

(51) Int. Cl. H04W 48/18; H04W 88/06; H04M 7/00; H04L 29/06

(52) U.S. Cl. CPC H04W 48/18; H04L 65/1016; H04L 65/1073; H04W 88/06; H04M 7/006

(57) ABSTRACT

Aspects of deferred domain selection in a mobile communications network are described. In one embodiment, a user equipment (UE) device initiates an attachment procedure with at least one radio access technology network. Then, when originating a voice call, the UE device determines whether the UE device is registered for internet protocol multimedia subsystem (IMS) services. When the UE device is not yet registered for IMS services, the UE device defers domain selection for the voice call. In certain aspects, while the UE device defers domain selection for the voice call, the UE device evaluates a set of IMS registration tendency factors for at least a predetermined timeout period. The IMS registration tendency factors may include an indicator of whether IMS registration is ongoing, an indicator of whether the UE device was successful in prior IMS registration requests, or a user's network preference setting in the UE device.

Internet protocol multimedia subsystem (IMS) services provide a framework for delivering internet protocol (IP) multimedia services over evolved mobile communications networks. The suite of IMS services was developed by various standards bodies including the 3rd generation partnership project (3GPP), to expand and evolve wireless mobile networks beyond global system for mobile communication (GSM) systems.

To integrate IMS services with packet-based networks, such as the Internet, IMS services rely upon session control protocols, such as session initiation protocol (SIP) or bearer-independent call control (BICC), for example, to establish communications sessions for various services. SIP is one example of a standard networking protocol relied upon by IMS services to establish, modify, and terminate IP-based communication sessions. The IP-based communication sessions may include data communication, voice communication, multimedia (text, audio, video, and/or data) conference collaboration, instant messaging, and application sharing services, for example.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 illustrates a system for deferred domain selection in a mobile communications network according to an example embodiment.

FIG. 2 illustrates elements of a user equipment device in the system of FIG. 1 according to an example embodiment.

FIG. 3 illustrates a process of domain selection which may be performed by a user equipment device in a mobile communications network according to an example embodiment.

FIG. 4 illustrates a process of deferred domain selection which may be performed by the user equipment device in the system of FIG. 1 according to an example embodiment.

FIG. 5 illustrates an example schematic block diagram of a computing architecture which may be employed by the user equipment device in the system of FIG. 1 according to an example embodiment.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions or positions of elements and features may be exaggerated to help visually convey certain principles. In the drawings, similar reference numerals between figures designate like or corresponding, but not necessarily the same, elements.

### DETAILED DESCRIPTION

In the following paragraphs, various embodiments are described in further detail by way of example with reference to the attached drawings. In the description, well known components, methods, and/or processing techniques are omitted or briefly described so as not to obscure the embodiments.

As outlined above, IMS services provide a framework for delivering IP multimedia services, such as packet switched voice communications sessions, over evolved mobile communications networks. Generally, when an IMS-capable user equipment (UE) device is turned on, it attaches to a mobile communications network by requesting, from a management entity of the mobile communications network, one or more radio bearers, such as default, dedicated, or signaling radio bearers, for example, for data communications. In turn, the management entity may provision the one or more radio bearers to the UE device. In doing so, a packet data network connection is established between the UE device and the mobile communications network. To operate using IMS services, the UE device may also apply for an IMS access point name (APN), be assigned an IMS domain reference, and initiate an IMS domain registration process. Once the IMS domain registration process is complete, the UE device is ready to operate using IP multimedia services, such as packet switched voice communications sessions, multimedia (text, audio, video, and/or data) conference collaboration, instant messaging, and application sharing services, for example, over an evolved mobile communications network.

It is noted that mobile communications networks have evolved through various radio access technologies (RATs) over time. For example, the global system for mobile (GSM) communications standard has evolved into enhanced data rates for GSM evolution (EDGE), high speed packet access (HSPA), Code Division Multiple Access (CDMA), Universal Mobile Telecommunications System (UMTS), Long Term Evolution (LTE), and LTE advanced communications standards. At least to some extent, mobile communications networks are RAT heterogeneous, operating across various levels of technology evolution in communications standards. It is also noted that newer communications standards, such as LTE and LTE advanced, for example, may operate with packet switched (PS) core networks, while older communications standards (e.g., EDGE, HSPA, etc.) may operate with a combination of packet and circuit switched (CS) core networks.

Certain mobile communications standards provide a solution for establishing voice communications sessions (e.g., voice calls, voice over LTE (VoLTE) calls, etc.) over evolved PS networks (e.g., LTE, LTE advanced, etc.), with additional support for CS fall back (CSFB) over legacy PS/CS networks (e.g., EDGE, HSPA, etc.). Because of the cost and time needed to establish LTE networks, network operators may rely upon CSFB at least to a certain extent depending upon their deployment strategy for evolved network service. For example, operators with aggressive LTE deployment strategies may seek to provide voice communications sessions over evolved PS networks more quickly, and aggressively evolve to richer multimedia services. Operators with less aggressive LTE deployment and/or spotty LTE coverage may rely upon CSFB to avoid dropped calls.

It is noted that the application for an IMS APN and IMS domain registration may take a certain amount of time in addition to the time required for a UE device to attach to a heterogeneous communications network. In this context, under certain operating conditions, a UE device may fallback using CSFB on a legacy network if a voice call is originated by the UE device while the UE device is awaiting IMS domain registration on an evolved network (even if the UE device is attached to the evolved network but awaiting IMS domain registration). For example, when the UE device is first turned on and attached to a heterogeneous communications network, IMS registration may be ongoing when a user of the UE device prompts the UE device to originate a voice call. Even if IMS registration will ultimately be successful, the UE device may immediately fallback using CSFB on a legacy network to place the voice call, regardless of the fact that IMS registration may be nearly imminent. In other words, when determining whether to fallback to a CS voice call on a legacy network during a pending IMS registration, the UE device may only consider whether it is registered or unregistered for IMS services, without considering other pertinent factors.

UE device CSFB fallback for a voice call generally requires RAT reselection to a legacy network (e.g., fallback from a LTE or LTE advanced RAT to an EDGE, HSPA, etc. RAT), which may lead to lower overall bandwidth in mobile communications services for the UE device. Further, depending upon certain factors, once a UE device has reselected to a legacy network using CSFB, the UE device may linger in the legacy network, which may be undesirable for a user of the UE device. Thus, to avoid unnecessary and/or undesirable RAT reselection, when determining whether to fallback to a CS voice call over a legacy network during a pending IMS registration, it may be desirable for the UE device to defer domain (i.e., RAT) selection for at least a limited predetermined period of time and/or consider other IMS registration tendency factors to gauge the likelihood that IMS registration may be nearly imminent.

In the context outlined above, the embodiments described herein are directed to aspects of deferred domain selection in a mobile communications network. In one embodiment, a UE device initiates an attachment procedure with at least one radio access technology network. Then, when originating a voice call, the UE device determines whether the UE device is registered for internet protocol multimedia subsystem (IMS) services. When the UE device is not yet registered for IMS services, the UE device defers domain selection for the voice call. In certain aspects, while the UE device defers domain selection for the voice call, the UE device evaluates a set of IMS registration tendency factors for at least a predetermined timeout period. The IMS registration tendency factors may include an indicator of whether IMS registration is ongoing, an indicator of whether the UE device was successful in prior IMS registration requests, or a user's network preference setting in the UE device.

Turning now to the drawings, a description of exemplary embodiments of a system and its components are provided, followed by a discussion of the operation of the same.

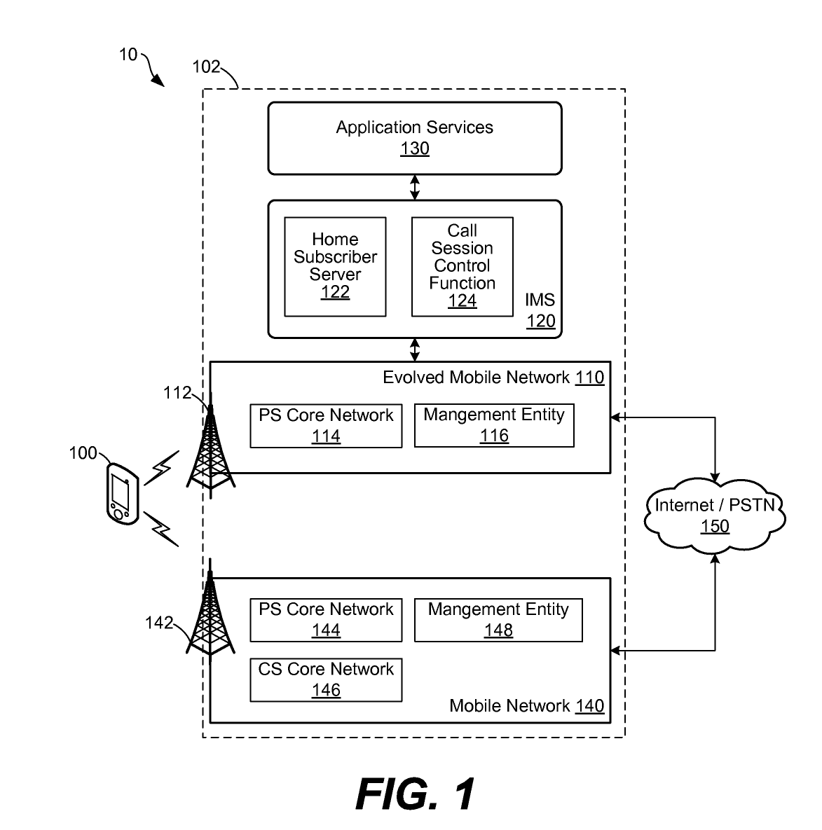

FIG. 1 illustrates a system 10 for deferred domain selection in a mobile communications network according to an example embodiment. The system 10 includes a UE device 100, a heterogeneous mobile communications network 102, and an external network 150, such as the Internet and/or the public switched telephone network (PSTN). The external network 150 is coupled to the heterogeneous network 102 so that the heterogeneous network 102 may facilitate Internet and/or the PSTN connectivity access, for example, to the UE device 100.

In various embodiments, the UE device 100 may be embodied as any computing device capable of establishing a communications session with the heterogeneous network 102, such as a laptop (or desktop) computer, a cellular telephone, a tablet computing device, a portable media player, a digital camera, etc., without limitation. In aspects of the embodiments described herein, the UE device 100 is capable of communicating over different RATs of the heterogeneous network 102 and supports IMS services over evolved mobile networks (i.e., the UE device 100 is an IMS-capable device). Among other known and/or common elements in such devices, the UE device 100 may be embodied as one or more general- or specific-purpose circuits, processing circuits, memories, or any combination thereof.

The heterogeneous network 102 includes an evolved mobile communications network 110, an IMS services module 120, an application services module 130, and a mobile communications network 140. Generally, the heterogeneous network 102 may be considered “heterogeneous” because it includes radio access technologies at various stages of evolution. The evolved mobile network 110 may be embodied as a network which has evolved to include increased bandwidth and/or mobile communications services as compared to the mobile network 140. For example, the evolved mobile network 110 may be embodied as an evolved network, such as an LTE or LTE advanced network, without limitation, and the mobile network 140 may be embodied as a pre-evolved or legacy network, such as a GSM, EDGE, or HSPA network, without limitation. It should be appreciated that the heterogeneous network 102 may include other elements which are omitted from the description herein for brevity.

As illustrated in FIG. 1, the evolved mobile network 110 includes a base station 112, a PS core network 114, and a management entity 116. The mobile network 140 includes a base station 142, a PS core network 144, a CS core network 146, and a management entity 148. Each of the networks 110 and 140 may be embodied, in part, as one or more general- or specific-purpose circuits, processing circuits, memories, or any combination thereof. The base station 112 may be embodied as one or more suitable base transceiver stations (BTSs) (e.g., eNodeb stations and supporting infrastructure, etc.) for the evolved mobile network 110 including equipment that facilitates wireless communication between the UE device 100 and the PS core network 114. Similarly, the base station 142 may be embodied as one or more suitable BTSs (e.g., Nodeb stations and supporting infrastructure, etc.) for the mobile network 140 including equipment that facilitates wireless communication between the UE device 100 and the PS and CS core networks 144 and 146.

The PS core network 114, the PS core network 144, and the CS core network 146 may be embodied as network core elements that route and switch data and signaling communications channels for the heterogeneous network 102, so that the heterogeneous network 102 may provide services to, among, and between the UE device 100, other UE devices, and the external network 150. Here, it is noted that the evolved mobile network 110 does not include a CS core network as does the mobile network 140.

The management entity 116 may be embodied as a control plane for the evolved mobile network 110 including one or more general- or specific-purpose circuits, processing circuits, memories, or any combination thereof that manages and/or controls operations of the evolved mobile network 110. For example, the management entity 116 may be responsible for authenticating the UE device 100 with an operator's public land mobile network (PLMN) identifier and enforcing roaming restrictions, geographically tracking the UE device 100 among BTSs, BTS node reselection, radio bearer activation/deactivation processes, and establishing communications with gateway devices coupled to the external network 150, for example. Similarly, the management entity 148 may be embodied as a control plane for the mobile network 140 including one or more general- or specific-purpose circuits, processing circuits, memories, or any combination thereof that manages and/or controls operations of the mobile network 140.

As further illustrated in FIG. 1, the IMS services module 120 includes a home subscriber server (HSS) 122 and a call session control function (CSCF) 124. The HSS 122 may be embodied as a services authentication and registration plane for IMS services in the evolved mobile network 110. The HSS 122 may include a database of IMS network entities (e.g., UE devices) for which IMS support is available. In this context, the HSS 122 may maintain IMS subscription information and profiles, perform IMS authentication and authorization, assign IMS APNs, and perform IMS registration, for example, among other IMS-supporting services.

The CSCF 124 includes a control plane for IMS services. In operation, the CSCF 124 may act as a SIP proxy that authorizes resources, controls quality of service (QoS), inspects SIP signaling, and compress and decompress SIP data, for example. The CSCF 124 may also handle SIP address registrations and determine where SIP data packets are to be forwarded. For example, as the application services 130 may include voice communication, multimedia (text, audio, video, and/or data) conference collaboration, instant messaging, and application sharing services, for example, the CSCF 124 may determine to which services the SIP data packets are to be forwarded.

In the overall context of the system 10, when the UE device 100 is turned on, it attaches to the heterogeneous network 102 by requesting, from one or more of the management entities 116 and/or 148, access to one or more radio bearers for communications. In turn, the management entities 116 and/or 148 may provision the one or more radio bearers to the UE device 100. Further, to operate using IMP services over the evolved mobile network 110, the UE device 100 may also apply to the IMS services module 120 for an IMS APN and initiate an IMS domain registration process with the IMS services module 120. Once the IMS domain authentication and registration process is complete with the IMS services module 120, the UE device 100 is ready to deliver IP multimedia services, such as packet switched voice communication, multimedia (text, audio, video, and/or data) conference collaboration, instant messaging, and application sharing services, for example, over the evolved mobile network 110.

It is noted that the UE device 100 may originate and connect an outbound voice call via the heterogeneous network 102 using either the evolved mobile network 110 or the mobile network 140. If the voice call is connected via the evolved mobile network 110, then the voice call would be routed through the PS core network 114, for example, using IMS voice services. On the other hand, if the voice call is connected via the mobile network 140, then the voice call would be routed through the CS core network 146 (without using IMS voice services). While the heterogeneous network 102 may generally seek to connect an outbound voice communications session (e.g., a voice call) which is originated by the UE device 100 over the PS core network 114 of the evolved mobile network 110, if possible, the heterogeneous network 102 also supports connection of such sessions over the CS core network 146 of the mobile network 140 by fallback using CSFB. CSFB may be relied upon in various circumstances, such as when the UE device 100 has not or cannot register with the IMS services module 120 of the evolved mobile network 110, for example.

Here, it is noted that the application for an IMS APN and IMS domain registration may take a certain amount of time in addition to the time required for the UE device 100 to attach to the heterogeneous network 102. In this context, rather than originating a voice call over the evolved mobile network 110, the UE device 100 may fallback to CSFB over the mobile network 140, for example, if the UE device 100 is awaiting IMS domain registration on the evolved mobile network 110. For example, when the UE device 100 is first turned on and attached to the heterogeneous network 102, IMS registration may be ongoing in the IMS services module 120 when a user of the UE device 100 prompts the UE device 100 to originate a voice call. Even if IMS registration will ultimately be successful in the IMS services module 120, the UE device 100 may immediately fallback using CSFB to the mobile network 140 to place the voice call, regardless of the fact that IMS registration in the IMS services module 120 may be a relative certainty and/or nearly imminent. According to aspects of the embodiments described herein, when determining whether to fallback to a CS voice call over the mobile network 140 during a pending IMS registration, the UE device 100 may consider factors in addition to whether it is registered or unregistered for IMS services in the IMS services module 120, as further described below.

CSFB fallback for a voice call generally requires RAT reselection from the evolved mobile network 110 to the mobile network 140, which may lead to lower overall bandwidth in mobile communications services for the UE device 100. Further, depending upon certain factors, once the UE device 100 has selected the mobile network 140 using CSFB, the UE device 100 may linger in the mobile network 140, despite the fact that a user of the UE device 100 may prefer service via the evolved mobile network 110. Thus, to avoid unnecessary and/or undesirable RAT reselection, when determining whether to fallback to a CS voice call over a legacy network during a pending IMS registration, it may be desirable for the UE device 100 to defer domain (i.e., RAT) selection for at least a limited predetermined period of time and/or consider other IMS registration tendency factors to gauge the likelihood that IMS registration may be ultimately successful and/or nearly imminent.

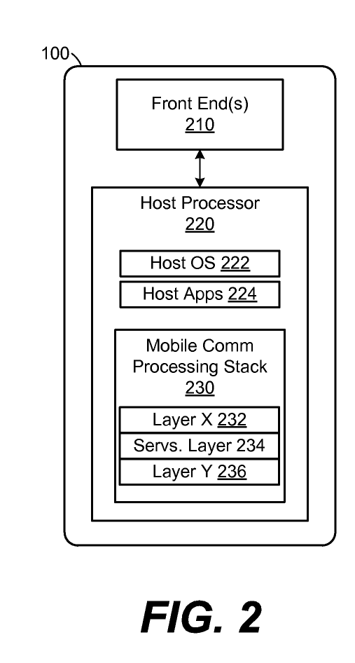

FIG. 2 illustrates elements of the UE device 100 in the system 10 of FIG. 1 according to an example embodiment. As illustrated in FIG. 2, among other known and/or common elements in such devices, the UE device 100 comprises a front end 210 and a host processor 220. The front end 210 comprises RF front end circuitry that supports wireless communications between the UE device 100 and the heterogeneous network 102. For example, the front end 210 may comprise one or more antennas, mixers, and duplexers. The front end 210 may further comprise filtering circuitry (e.g., band pass, band stop, blocking, etc., filters) and amplifiers to support wireless communications.

The host processor 220 coordinates the overall operations of the UE device 100, and is capable of executing a host operating system (OS) 222 and host applications 224, for example, for the UE device 100. The host processor 220 also includes circuitry associated with and/or is capable of executing a mobile communications processing stack 230. Further, although not illustrated, the host controller 220 may be capable of controlling or coordinating other elements of the UE device 100, such as a display, a speaker, a microphone, and a camera, for example.

The mobile communications processing stack 230 includes various control and/or signaling layers for wireless communications with the heterogeneous network 102 (FIG. 1), including layer X 232, a services layer 234, and layer Y 236. The layers 232, 234, and 236 may be embodied as abstraction layers of a system model for wireless communications with the heterogeneous network 102. For example, the layers 232, 234, and 236 may be considered similar to layers of the Open Systems Interconnection (OSI) model (but tailored for wireless communications with the heterogeneous network 102), such as access stratum, session, transport, and network layers, for example. It is noted that the layers 232, 234, and 236 may coordinate session management, flow control, logical and/or physical addressing, or data transmission, among other functions. The layers 232, 234, and 236 are provided by way of example only and are not to be considered limiting, as certain layers may be omitted or added in various embodiments.

In certain aspects, the services layer 234 operates to select and/or defer selection of RAT domain access with the heterogeneous network 102. In this context, by the direction, at least in part, of the services layer 234, the UE device 100 may initiate a mobile communications attachment procedure with the heterogeneous network 102 (FIG. 1), and determine whether the UE device 100 is registered for IMS services with the evolved mobile network 110 of the heterogeneous network 102. When a voice communications call is originated by the UE device 100, the services layer 234 may select the evolved mobile network 110 for placement of the voice communications call when the UE device 100 is registered for IMS services. On the other hand, the services layer 234 may defer domain selection (e.g., selection among the evolved mobile network 110 and the mobile network 140) for placement of the voice communications call when the UE device 100 is not yet registered for IMS services.

According to certain aspects of the embodiments described herein, while deferring domain selection for the voice communications call, the services layer 234 may evaluate a set of IMS registration tendency factors. Ultimately, the evaluation of the factors may lead or tend to the UE device 100 waiting for IMS registration for placement of the voice communications call over the evolved mobile network 110, or fallback using CSFB to the mobile network 140 for placement of the voice communications call (without any further defer or delay or for IMS registration to conclude).

In this context, the evaluation of the factors may be directed to determining a likelihood that IMS registration will be ultimately successful, although ongoing. The set of IMS registration tendency factors may include, among others, an indicator of whether IMS registration is ongoing, an indicator of whether the UE device was successful in prior requests for IMS registration, or a network preference setting in the UE device. While deferring domain selection for the voice communications call, the services layer 234 may also evaluate operator policy settings of the heterogeneous network 102. The operator policy settings may include at least one of a circuit switched fall back preference setting, a data centric policy setting, or a voice centric operator policy setting. In other aspects, the services layer 234 may consider other factors, such as whether the call is a call to emergency services (e.g., a “911” call).

In other aspects, the services layer 234 may processes an IMS registration loop timer for a predetermined period of time while evaluating the set of IMS registration tendency factors. If the IMS registration loop timer expires while evaluating the set of IMS registration tendency factors, then the services layer 234 may fallback to the mobile network 140 using CSFB for placement of the voice communications call.

According to aspects of the embodiments described herein, an unnecessary and/or undesirable RAT reselection to a legacy mobile network may be avoided, while awaiting registration for IMS services, by deferring domain selection while quickly gauging the likelihood of success of IMS services registration. Even if domain selection (and placement of a voice call) is deferred for a short period of time, the delay may be justified to maintain the enhanced services provided by an evolved mobile network.

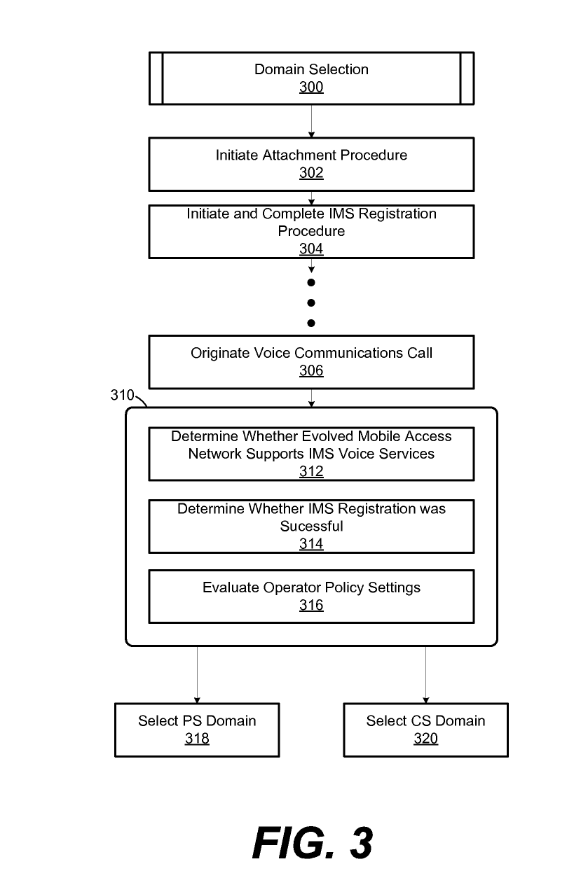

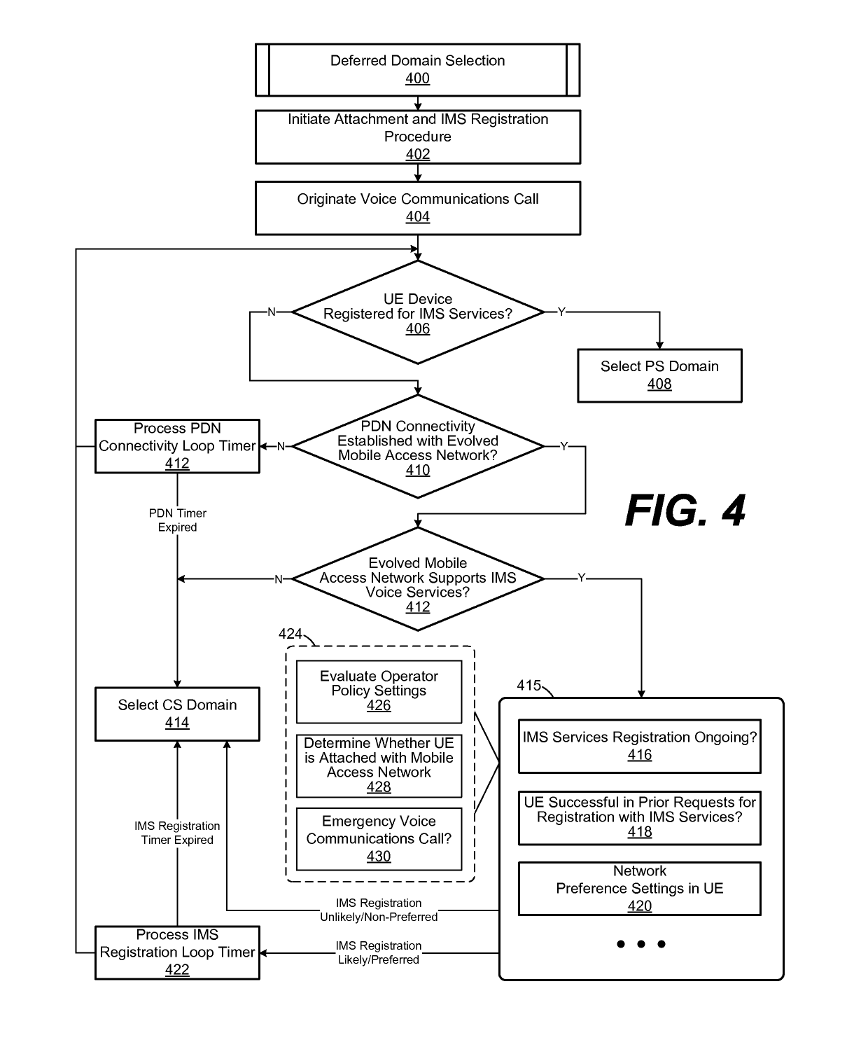

Before turning to the process flow diagrams of FIGS. 3 and 4, it is noted that the embodiments described herein may be practiced using an alternative order of the process flow illustrated in FIGS. 3 and 4. That is, the process flows illustrated in FIGS. 3 and 4 are provided as examples only, and the embodiments may be practiced using process flows that differ from those illustrated. Additionally, it is noted that not all steps are required in every embodiment. In other words, one or more of the steps may be omitted or replaced, without departing from the spirit and scope of the embodiments. Further, steps may be performed in different orders, in parallel with one another, or omitted entirely, and/or certain additional steps may be performed without departing from the scope and spirit of the embodiments.

FIG. 3 illustrates a process 300 of domain selection which may be performed by a user equipment device in a mobile communications network according to an example embodiment. While the process 300 is described in connection with the system 10 and the UE device 100 of FIG. 1 for example context, it should be appreciated that the process 300 may be conducted by other systems and UE devices. At reference numeral 302, the process 300 includes initiating, by a UE device, a mobile communications attachment procedure with at least one radio access technology network. In the context of the system 10 of FIG. 1, the UE device 100 may initiate a mobile communications attachment procedure with the heterogeneous network 102, including the evolved mobile network 110 and/or the mobile network 140, for example, at reference numeral 302. The attachment procedure may occur when the UE device 100 is first turned on, when wireless communications services of the UE device 100 are activated (e.g., when airplane mode is turned off), or when the UE device 100 comes into sufficient geographic proximity to the heterogeneous network 102 for communications, for example. In turn, the management entities 116 and/or 148 may provision the one or more radio bearers to the UE device 100, and the UE device 100 may be attached to the evolved mobile network 110 and/or the mobile network 140 at reference numeral 302. In this context, upon attachment of the UE device 100 with the evolved mobile network 110, a packet data network may be established between the UE device 100 and the evolved mobile network 110.

At reference numeral 304, the process 300 includes initiating and, in certain circumstances, completing an IMS registration procedure. With reference again to FIG. 1 for example context, the UE device 100 may initiate an IMS registration procedure with the IMS services module 120 at reference numeral 304. In turn, the IMS services module 120 may assign an IMS APN to the UE device 100 and register the UE device 100 for IMS services. Once the IMS domain authentication and registration process are complete with the IMS services module 120, the UE device 100 is ready to deliver IP multimedia services, such as packet switched voice communication, multimedia (text, audio, video, and/or data) conference collaboration, instant messaging, and application sharing services, for example, over the evolved mobile network 110.

At some time later, at reference numeral 306, the process 300 includes originating a voice communications call. For example, the UE device 100 may be directed (e.g., by a user dialing and sending a call) to originate a voice communications call at reference numeral 308. After reference numeral 308 and in response to the origination of the call, the process 300 includes evaluating a set of factors at reference numeral 310, to determine whether to place the voice communications call over one or more different radio access technology networks. In the context of the system 10 of FIG. 1, the UE device 100 may determine whether to place the voice communications call over the evolved mobile network 110 and/or the mobile network 140 based on the evaluation of the set of factors at reference numeral 310.

The evaluation of the set of factors at reference numeral 310 may include one or more of the steps of determining whether the evolved mobile communications network supports IMS voice services at reference numeral 312, determining whether IMS services registration (i.e., at reference numeral 304) was successful at reference numeral 314, and/or determining and considering operator policy settings at reference numeral 316. It is noted that, after attaching with the heterogeneous network 102 (FIG. 1) at reference numeral 302, the UE device 100 may receive an indication from the evolved mobile network 110 as to whether the evolved mobile network 110 supports IMS services. If it is determined that the evolved mobile network 110 does not support IMS services at reference numeral 312 based on the indication, then the process 300 proceeds to reference numeral 320, where the UE device 100 may fallback using CSFB to the mobile network 140 for placement of the voice communications call originated at reference numeral 308.

Similarly, if it is determined at reference numeral 314 that IMS registration (i.e., at reference numeral 304) was not successful, then the process 300 proceeds to reference numeral 320, where the UE device 100 may fallback using CSFB to the mobile network 140 for placement of the voice communications call originated at reference numeral 308. Additionally, based on one or more operator policy settings evaluated at reference numeral 316, the process 300 may proceed to reference numeral 320, where the UE device 100 may fallback using CSFB, or the process 300 may proceed to reference numeral 318, where the UE device 100 may rely upon the evolved mobile network 110 for placement of the voice communications call.

In the overall context of the process 300, domain selection in connection with the evaluating at reference numeral 310 may take into account whether a UE device is roaming, aspects of service subscription, and operator policies. With regard to operator policies, a UE device may be attributed by an operator to behave as a “voice centric” or “data centric” device in a heterogeneous network. For a UE device set to behave as a data centric device, a heterogeneous network may attempt to ensure that PS voice services are achieved using IMS services over an evolved mobile network, at least to the extent possible. Even if a UE device is attributed by an operator to behave as a data centric device, for example, if the UE device is unable to obtain IMS voice services in an evolved mobile network (e.g., IMS voice services are not supported or preferences prevent usage of voice services), the UE device may proceed to fallback using CSFB (i.e., proceed to reference numeral 320). On the other hand, for a UE device set to behave as a voice centric device, the heterogeneous network may permit and/or require the UE device to fallback using CSFB to a legacy mobile network any time a voice communications call is originated.

It is noted that, in the domain selection process 300, before the voice communications call is originated at reference numeral 308, IMS registration is complete (i.e., at reference numeral 304). In other words, in the domain selection process 300, the evaluation of the set of factors at reference numeral 310 occurs after IMS registration for the UE device is complete (e.g., registration successful or unsuccessful). In contrast, the deferred domain selection process 400 described below includes the evaluation of certain IMS registration tendency factors while IMS registration is pending or ongoing.

FIG. 4 illustrates a process 400 of deferred domain selection which may be performed by the UE device 100 in the system 10 of FIG. 1 according to an example embodiment. While the process 400 is described in connection with the system 10 and the UE device 100 of FIG. 1 for example context, it should be appreciated that the process 400 may be conducted by other systems and UE devices. At reference numeral 402, the process 400 includes initiating, by a UE device, a mobile communications attachment procedure with at least one radio access technology network. With reference to the system 10 of FIG. 1 for example context, the UE device 100 may initiate a mobile communications attachment procedure with the heterogeneous network 102, including the evolved mobile network 110 and/or the mobile network 140, for example, at reference numeral 402. Further, at reference numeral 402, the UE device 100 may initiate an IMS registration procedure with the IMS services module 120 at reference numeral 402. While this IMS registration procedure is ongoing with the heterogeneous network 102, the process 400 proceeds as further described below.

At reference numeral 404, the process 400 includes originating a voice communications call. In turn, the process 400 proceeds to reference numeral 406, which includes determining whether the UE device 100 is registered for services with an evolved mobile communications network via the attachment procedure at reference numeral 402, for example. If it is determined, at reference numeral 406, that the UE device 100 is registered for IMS services at reference numeral 406, then the process 400 proceeds to reference numeral 408, where the UE device 100 relies upon the evolved mobile network 110 for placement of the voice communications call. On the other hand, if it is determined, at reference numeral 406, that the UE device 100 is not yet registered for IMS services (e.g., if IMS services registration is ongoing), then the process 400 proceeds to reference numeral 410. In this case, when the UE device 100 is not yet registered for IMS services, then domain selection is deferred for the voice communications call originated at reference 404.

When domain selection is deferred, the process 400 includes determining whether packet data network connectivity is established with an evolved mobile communications network at reference numeral 410. For example, the UE device 100 may determine whether packet data network connectivity is established with the evolved mobile network 110 of the heterogeneous network 102 (FIG. 1) at reference numeral 410. In this context, the determination at reference numeral 410 hinges upon whether the management entity 116 of the evolved mobile network 110 has provisioned one or more radio bearers to the UE device 100 at reference numeral 402, so that packet data network connectivity is available with the evolved mobile network 110.

If, at reference numeral 410, packet data network connectivity is not available, then the process 400 proceeds to reference numeral 412, which includes processing a packet data network connectivity loop timer for at least a predetermined period of time while awaiting for packet data network connectivity. Referring to FIG. 1, the UE device 100 may process a packet data network connectivity loop timer for at least a predetermined period of time while awaiting for packet data network connectivity with the evolved mobile network 110 at reference numeral 412. In one embodiment, the packet data network connectivity loop timer may be maintained by the services layer 234 of the UE device 100 (FIG. 2).

Thus, so long as IMS registration is ongoing (e.g., “N” at reference numeral 406), the process 400 includes determining, in a loop including reference numerals 410 and 412, whether packet data network connectivity is available for at least a predetermined period of time pursuant to the countdown processing of the packet data network connectivity loop timer. As illustrated in FIG. 4, when the packet data network loop timer expires (i.e., “PDN timer expired” branch) at reference numeral 412, the process 400 includes selecting, at reference numeral 414, a circuit switched domain for the voice communications call originated at reference numeral 404. Here, the process 400 accounts for the condition that a UE device may not be able to establish communications with the evolved mobile network 110. This condition may occur for various reasons, such as lack of capacity, certain operator settings, or PLMN identifier mismatch on the evolved mobile network 110, for example.

If it is determined that packet data network connectivity is established at reference numeral 410, the process 400 proceeds to reference numeral 412. At reference numeral 412, the process 400 includes determining whether the evolved mobile communications network supports IMS voice services. It is noted that, when attaching with the heterogeneous network 102 (FIG. 1) at reference numeral 402, the UE device 100 may receive an indication from the evolved mobile network 110 as to whether the evolved mobile network 110 supports IMS services. If it is determined that the evolved mobile network 110 does not support IMS services at reference numeral 412 based on the indication, then the process 400 proceeds to reference numeral 414, where the UE device 100 may fallback using CSFB to the mobile network 140 for placement of the voice communications call originated at reference numeral 404. Alternatively, if it is determined that the evolved mobile network 110 does support IMS services at reference numeral 412, then the process 400 proceeds to reference numeral 415, which includes evaluating a set of IMS registration tendency factors.

At reference numeral 415, the evaluation of the factors may be directed to determining, comparing, and/or evaluating an indicator of whether IMS registration is ongoing at reference numeral 416, an indicator of whether the UE device was successful in prior requests for IMS registration at reference numeral 418, and/or network preference settings in the UE device at reference numeral 420. It should be appreciated that the factors for evaluation at reference numeral 415 are provided by way of example and not limitation. In various embodiments, other suitable factors may be considered. Further, it should be appreciated that not every factor must be considered in every embodiment.

In certain embodiments, the evolved mobile network 110 may provide the UE device 100 with an indication as to whether IMS registration is pending or ongoing. For example, after IMS registration is initiated by the UE device 100, the CSCF 124 (FIG. 1) may provide feedback to the UE device 100 as to the status of IMS APN and/or SIP address registration, for example. Using this feedback, at reference numeral 416, the UE device 100 may evaluate and/or consider the likelihood that IMS registration will ultimately be successful. For example, if multiple steps are required for IMS registration, the UE device 100 may consider it likely that IMS registration will be successful when a certain percentage or threshold number of the steps are complete. Alternatively or additionally, the UE device 100 may consider it likely that IMS registration will be successful when one or more critical IMS registration steps are complete.

Further, in certain embodiments, the UE device 100 may store a history of whether it was successful in prior requests for registration with IMS services. In turn, the UE device 100 may use this stored information when considering the likelihood that IMS registration will be successful at reference numeral 418. For example, if the UE device 100 was successful in prior requests for registration with IMS services, then the UE device 100 may consider it likely that IMS registration will ultimately be successful at reference numeral 418. Alternatively, if the UE device 100 was not successful in prior requests for registration with IMS services, then the UE device 100 may consider it unlikely that IMS registration will be successful at reference numeral 418.

In other aspects, the UE device 100 may store a user's preference for data and/or voice services. This preference may be selected by a user of the UE device 100 in an interface menu, for example. In turn, the UE device 100 may use this stored information when determining whether to continue to wait for IMS registration. For example, if a user of the UE device 100 prefers data services, then the UE device 100 may consider this as a factor tending toward waiting for IMS registration at reference numeral 420. Alternatively, if a user of the UE device 100 prefers voice services, then the UE device 100 may consider this as a factor tending against waiting for IMS registration at reference numeral 420.

In certain embodiments, the UE device 100 may determine a weighted average of one or more of the IMS registration tendency factors evaluated at reference numeral 415. Based on the evaluation, the process 400 proceeds either to reference numeral 415 or reference numeral 422. That is, when the balance of the evaluation at reference numeral 415 suggests that IMS registration is unlikely and/or not preferred, the process 400 proceeds to reference numeral 414, which includes selecting a circuit switched domain for the voice communications call originated at reference numeral 404. On the other hand, when the balance of the evaluation at reference numeral 415 suggests that IMS registration is likely and/or preferred, the process 400 proceeds to reference numeral 422, which includes processing an IMS registration loop timer for a predetermined period of time while further evaluating the set of IMS registration tendency factors. In one embodiment, the IMS registration loop timer may be maintained by the services layer 234 of the UE device 100 (FIG. 2). Similarly, the evaluation at reference numeral 414 may be conducted by the services layer 234.

Thus, so long as IMS registration is ongoing (e.g., “N” at reference numeral 406), packet data network connectivity is established (e.g., “Y” at reference numeral 410), and the evolved mobile network supports IMS voice services (e.g., “Y” at reference numeral 412), the process 400 includes further evaluating, in a loop including reference numerals 415 and 422, whether IMS registration is likely to be successful and/or whether data services are preferred. The ongoing evaluation and deferral of domain selection may continue for at least a predetermined period of time pursuant to the countdown processing of the IMS registration loop timer loop timer. As illustrated in FIG. 4, when the IMS registration loop timer expires (i.e., “IMS registration timer expired” branch) at reference numeral 422, the process 400 includes selecting, at reference numeral 414, a circuit switched domain for the voice communications call originated at reference numeral 404. Here, the process 400 accounts for the fact that the UE device 100 cannot defer domain selection indefinitely, even if it appears likely that IMS registration will ultimately be successful.

At reference numeral 424, in certain embodiments, the evaluation at reference numeral 415 may be further directed by the determination and/or consideration of operator policy settings, whether communications with a legacy network have been established, and/or whether the call originated at reference numeral 404 is for emergency services. For example, the process 400 may include determining or considering a data centric and/or a voice centric operator policy setting at reference numeral 428, whether communications with a legacy network have been established at reference numeral 426, and/or whether the call originated at reference numeral 404 is for emergency services at reference numeral 430.

As described above, with regard to operator policies, a UE device may be attributed by an operator to behave as a “voice centric” or “data centric” device in a heterogeneous network. For a UE device set to behave as a data centric device, a heterogeneous network may attempt to ensure that PS voice services are achieved using IMS services over an evolved mobile network, at least to the extent possible. Even if a UE device is attributed by an operator to behave as a data centric device, for example, if the UE device is unable to obtain IMS voice services in an evolved mobile network (e.g., IMS voice services are not supported or preferences prevent usage of voice services), the UE device may proceed to fallback using CSFB (i.e., proceed to reference numeral 320). On the other hand, for a UE device set to behave as a voice centric device, the heterogeneous network may permit and/or require the UE device to fallback using CSFB to a legacy mobile network any time a voice communications call is originated. These considerations may weigh into the process 400, bearing on whether domain selection will be deferred or not.

In other aspects, it is noted that, if it is determined at reference numeral 428 that communications with a legacy network have not been established, then the UE device may continue to defer for IMS registration, because CSFB to the legacy network is not available. Also, if the call originated at reference numeral 404 is a call to emergency services (e.g., a “911” call), then the UE device may quickly proceed to reference numeral 414 for fallback using CSFB, in the interest of not deferring for IMS registration during an emergency.

According to aspects of the process 400 described above, to avoid unnecessary and/or undesirable RAT reselection, when determining whether to fallback to a CS voice call over a legacy network during a pending IMS registration, domain selection may be deferred for at least a limited predetermined period of time to consider IMS registration tendency factors and gauge the likelihood that IMS registration may be nearly imminent.

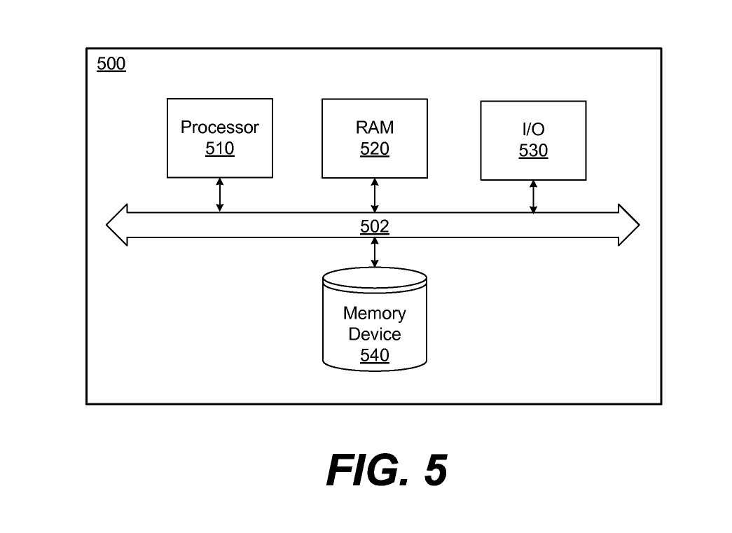

FIG. 5 illustrates an example schematic block diagram of a computing architecture 500 that may be employed by a UE device (e.g., the UE device 100 of FIGS. 1 and 2) according to various embodiments. The computing architecture 500 may be embodied, in part, using one or more elements of a mixed general and/or special purpose computer. The computing architecture 500 includes a processor 510, a Random Access Memory (RAM) 520, an Input Output (I/O) interface 530, and a memory device 540. The elements of computing architecture 500 are communicatively coupled via a local interface 502. The elements of the computing architecture 500 are not intended to be limiting in nature, as the architecture may omit elements or include additional or alternative elements.

In various embodiments, the processor 510 may include or be embodied as a general purpose arithmetic processor, a state machine, or an ASIC, for example. In various embodiments, the general- or specific-purpose processing circuits described herein may be implemented, at least in part, using the computing architecture 500 including the processor 510. The processor 510 may include one or more circuits, one or more microprocessors, ASICs, dedicated hardware, or any combination thereof. In certain aspects and embodiments, the processor 510 is configured to execute one or more software modules which may be stored, for example, on the memory device 540. In certain embodiments, the processes 300 and 400 in FIGS. 3 and 4 may be implemented or executed by the processor 510 according to instructions stored on the memory device 540.

The RAM 520 may include or be embodied as any random access and read only memory devices that store computer-readable instructions to be executed by the processor 510. The memory device 540 stores computer-readable instructions thereon that, when executed by the processor 510, direct the processor 510 to execute various aspects of the embodiments described herein.

As a non-limiting example group, the memory device 540 may include one or more non-transitory memory devices, such as an optical disc, a magnetic disc, a semiconductor memory (i.e., a semiconductor, floating gate, or similar flash based memory), a magnetic tape memory, a removable memory, combinations thereof, or any other known non-transitory memory device or means for storing computer-readable instructions. The I/O interface 530 includes device input and output interfaces, such as keyboard, pointing device, display, communication, and/or other interfaces. The one or more local interfaces 502 electrically and communicatively couple the processor 510, the RAM 520, I/O interface 530, and the memory device 540, so that data and instructions may be communicated among them.

In certain aspects, the processor 510 is configured to retrieve computer-readable instructions and data stored on the memory device 540 and/or other storage means, and copy the computer-readable instructions to the RAM 520 for execution. The processor 510 is further configured to execute the computer-readable instructions to implement various aspects and features of the embodiments described herein. For example, the processor 510 may be adapted or configured to execute the processes 300 and 400. In embodiments where the processor 510 includes a state machine or ASIC, the processor 510 may include internal memory and registers for maintenance of data being processed.

The flowchart or process diagrams of FIGS. 3 and 4 are representative of certain processes, functionality, and operations of embodiments described herein. Each block may represent one or a combination of steps or executions in a process. Alternatively or additionally, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as the processor 510. The machine code may be converted from the source code, etc. Further, each block may represent, or be connected with, a circuit or a number of interconnected circuits to implement a certain logical function or process step.

Although embodiments have been described herein in detail, the descriptions are by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. A method of deferred domain selection, comprising:
initiating, by a user equipment (UE) device, a mobile communications attachment procedure with at least one radio access technology network;
originating, by the UE device, a voice communications call;
determining whether the UE device is registered for services with an evolved mobile communications network via the attachment procedure; and
when the UE device is not yet registered for services with the evolved mobile communications network, deferring, by a processing circuit of the UE device, domain selection for the voice communications call.

2. The method of claim 1, wherein the services comprise internet protocol multimedia subsystem (IMS) services, and the method further comprises:
when the UE device is registered for IMS services, selecting a packet switched domain of the evolved mobile communications network for the voice communications call; and
when the UE device is not yet registered for IMS services, deferring domain selection for the voice communications call.

3. The method of claim 2, further comprising:
when the UE device is not yet registered for IMS services, determining whether packet data network connectivity is established with the evolved mobile communications network; and
when packet data network (PDN) connectivity is not yet established with the evolved mobile communications network, processing a PDN loop timer for a predetermined period of time while awaiting for PDN connectivity.

4. The method of claim 1, further comprising, when the PDN loop timer expires, selecting a circuit switched domain for the voice communications call.

5. The method of claim 1, wherein the services comprise internet protocol multimedia subsystem (IMS) services, and the method further comprises, when the evolved mobile communications network supports IMS voice services, evaluating a set of IMS registration tendency factors while deferring domain selection for the voice communications call.

6. The method of claim 5, wherein the set of IMS registration tendency factors include at least one of an indicator of whether IMS registration is ongoing, an indicator of whether the UE device was successful in prior requests for IMS registration, or a network preference setting in the UE device.

7. The method of claim 5, further comprising processing an IMS registration loop timer for a predetermined period of time while evaluating the set of IMS registration tendency factors.

8. The method of claim 7, further comprising, when the IMS registration loop timer expires, selecting a circuit switched domain for the voice communications call.

9. The method of claim 1, wherein the services comprise internet protocol multimedia subsystem (IMS) services, and the method further comprises:
while deferring domain selection for the voice communications call, evaluating operator policy settings, the operator policy settings including at least one of a circuit switched fall back preference setting, a data centric policy setting, or a voice centric operator policy setting.

10. A user equipment (UE) device, comprising:
communications front end circuitry; and
a host processing circuit, the host processing circuit comprising a mobile communications processing stack that:
initiates a mobile communications attachment procedure;
determines whether the UE device is registered for internet protocol multimedia subsystem (IMS) services with an evolved mobile communications network; and
defers domain selection for a voice communications call when the UE device is not yet registered for IMS services.

11. The device of claim 10, wherein the mobile communications processing stack further evaluates a set of IMS registration tendency factors while deferring domain selection for the voice communications call.

12. The device of claim 11, wherein the set of IMS registration tendency factors include at least one of an indicator of whether IMS registration is ongoing, an indicator of whether the UE device was successful in prior requests for IMS registration, or a network preference setting in the UE device.

13. The device of claim 11, wherein the mobile communications processing stack further processes an IMS registration loop timer for a predetermined period of time while evaluating the set of IMS registration tendency factors.

14. The device of claim 13, wherein the mobile communications processing stack further selects a circuit switched domain for the voice communications call when the IMS registration loop timer expires.

15. The device of claim 10, wherein the mobile communications processing stack further evaluates operator policy settings while deferring domain selection for the voice communications call, the operator policy settings including at least one of a circuit switched fall back preference setting, a data centric policy setting, or a voice centric operator policy setting.

16. A method of deferred domain selection, comprising:
initiating, by a user equipment (UE) device, a mobile communications attachment procedure;
determining whether the UE device is registered for internet protocol multimedia subsystem (IMS) services with an evolved mobile communications network; and
when the UE device is not yet registered for IMS services, deferring, by a processing circuit of the UE device, domain selection for a voice communications call.

17. The method of claim 16, further comprising, evaluating a set of IMS registration tendency factors while deferring domain selection for the voice communications call.

18. The method of claim 17, wherein the set of IMS registration tendency factors include at least one of an indicator of whether IMS registration is ongoing, an indicator of whether the UE device was successful in prior requests for IMS registration, or a network preference setting in the UE device.

19. The method of claim 17, further comprising processing an IMS registration loop timer for a predetermined period of time while evaluating the set of IMS registration tendency factors.

20. The method of claim 19, further comprising, when the IMS registration loop timer expires, selecting a circuit switched domain for the voice communications call.
